(19) United States
(12) Patent Application Publication
(10) Pub. No.: US 2007/0034565 A1
(43) Pub. Date: Feb. 15, 2007

(54) Method for treating a contaminated fluid

(75) Inventor: Jonathan Park, Chardon, OH (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: GasTran Systems

(21) Appl. No.: 11/541,766

(22) Filed: Oct. 2, 2006

Related U.S. Application Data
(63) Continuation-in-part of application No. 10/971,385, filed on Oct. 22, 2004.
(60) Provisional application No. 60/514,213, filed on Oct. 24, 2003.

(51) Int. Cl. C02F 3/00

(52) U.S. Cl. 210/619

(57) ABSTRACT

A method for treating a contaminated fluid includes a step of providing a rotating packed bed (RPB) reactor having a rotatable permeable element disposed within a chamber defining an interior region. The RPB reactor also includes at least one liquid inlet for infusing the contaminated fluid into the interior region, at least one gas inlet for introducing a dose of at least one dissolvable gas into the chamber, at least one gas outlet for removing the at least one dissolvable gas from the interior region, and at least one liquid outlet for removing a fluid from the interior region. The contaminated fluid is infused into the liquid inlet at an inlet flow rate. After causing the rotatable permeable element to spin at a tangential velocity, a dose of the dissolvable gas is then infused into the gas inlet and a treated fluid having a reduced number of contaminants is generated.

### RELATED APPLICATIONS

This application is a continuation-in-part of U.S. Patent Application Ser. No. 10/971,385, filed Oct. 22, 2004, which claims priority from U.S. Provisional Patent Application Ser. No. 60/514,213, filed Oct. 24, 2003. The subject matter of the aforementioned applications is incorporated herein by reference in their entireties.

### TECHNICAL FIELD

The present invention relates generally to methods for using mass transfer equipment to treat contaminated fluids, and more particularly to the combined use of an oxidizing agent and rotating packed bed technology to treat contaminated fluids.

### BACKGROUND OF THE INVENTION

The ability to treat organic and inorganic waste materials from industrial and municipal sources is a persistent and growing problem in the industrialized world. Several oxidative techniques have been developed for the destruction of these organic and inorganic materials, including, for example, ozonation.

Conventional methods for ozonating fluids include the use of venturi injectors and fine bubble diffusers. Venturi injectors work by forcing a fluid through a conical body which initiates a pressure differential between fluid inlet and outlet ports. This creates a vacuum inside the injector body, which initiates ozone suction through the suction port. Micro-sized bubbles are then formed as the ozonated stream of air is sucked into the fluid stream. Bubble diffusers work by emitting ozone through a porous base having a matrix-like microstructure while immersed in a fluid. Ozone permeates throughout the porous base and migrates through the minute passages of the matrix structure. The ozone reaches the surface of the base and forms minute bubbles. These small bubbles then rise through the liquid, forming an interface for mass transfer between ozone and liquid before reaching the surface of the liquid.

Despite their commercial use, conventional ozonation techniques suffer from several drawbacks. For instance, conventional techniques have long residence times due to their operation under a normal gravitational field, a limited surface area (i.e., at the gas-film interface) for ozone dissolution, and poor performance at variable flow rates. To temper the long residence times, conventional ozonation techniques attempt to increase ozonation by not only using equipment (i.e., large holding tanks) that is both expensive and voluminous, but also by conducting ozonation under high ozone/high pressure conditions.

### SUMMARY OF THE INVENTION

In one aspect of the present invention, a method is provided for treating a contaminated fluid. According to the inventive method, a rotating packed bed (RPB) reactor having a rotatable permeable element disposed within a chamber defining an interior region is provided. The RPB reactor also includes at least one liquid inlet for infusing the contaminated fluid into the interior region, at least one gas inlet for introducing a dose of at least one dissolvable gas into the chamber, at least one gas outlet for removing the at least one dissolvable gas from the interior region, and at least one liquid outlet for removing a fluid from the interior region. After causing the rotatable permeable element to spin at a tangential velocity, the contaminated fluid is infused into the at least one liquid inlet at an inlet flow rate and the dose of the at least one dissolvable gas is then infused into the at least one gas inlet. A treated fluid having a reduced number of contaminants is thereby generated.

In another aspect of the present invention, a method is provided for treating a contaminated fluid. According to the inventive method, a RPB reactor having a rotatable permeable element disposed within a chamber defining an interior region is provided. The RPB reactor also includes at least one liquid inlet for infusing the contaminated fluid into the interior region, at least one gas inlet for introducing a dose of ozone into the chamber, at least one gas outlet for removing the ozone from the interior region, and at least one liquid outlet for removing a fluid from the interior region. After causing the rotatable permeable element to spin at a tangential velocity, the contaminated fluid is infused into the at least one liquid at an inlet flow rate and a dose of ozone is then infused into the at least one gas inlet. A treated fluid having a reduced number of contaminants is thereby generated.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a schematic diagram showing a system for treating a contaminated fluid constructed in accordance with the present invention;

FIG. 2 is a cross-sectional view of a rotating packed bed reactor;

FIG. 3 is a process flowchart illustrating the method of the present invention; and

FIG. 4 is a schematic diagram showing an alternative embodiment of a system for treating a contaminated fluid.

### DETAILED DESCRIPTION

The present invention generally relates to the use of mass transfer equipment to treat contaminated fluids, and more particularly to the combined use of an oxidizing agent and rotating packed bed (RPB) technology to treat contaminated fluids.

The present invention provides, but is not limited to, a process for treating contaminated fluids from industrial and municipal sources. In addition, aspects of the present invention are at least partially designed for the remediation of these same contaminated fluids. As used herein, contaminated fluids can include: (1) waste from gas and oil-related processing, including waste pits, drilling mud, and refinery wastes; (2) waste from the chemical industry, including organic and petrochemical wastes; (3) waste from other industrial sources, such as waste metal, waste paints, waste solvents, and waste pulp and paper; (4) waste from mining operations; (5) flue gas contaminants, for example, from electrical power generation; (6) waste from dredging operations of harbors, channels and rivers; (7) waste generated by the textile industry (e.g., dye-containing fluids); and (8) waste generated from the food processing industry. Contaminated fluids can also include municipal sewage, waste from coal processes, and waste from agricultural sources. A contaminated fluid can be a liquid waste material or fluid containing a waste material. In some instances, the contaminated fluid may contain suspended solids.

The present invention is also capable of treating other types of contaminated fluids, including, but not limited to, well water (ie., water containing manganese and/or iron), water containing undesirable amounts of cyanide, waste water from livestock lagoons, municipal drinking water, laundry or wash water, water from aquatic recreational areas (e.g., pools, spas, etc.), and water containing compounds that have a high vapor pressure and low water solubility, i.e., volatile organic compounds.

The present invention is useful in the destruction, i.e., partial to complete oxidation, of organic and non-organic contaminants. Organic contaminants, for example, can be oxidized into sulfides, disulfides, sulfites, mercaptans, mercaptans (thio), polysulfide, phenols, benzenes, substituted phenols, alcohols/glycols, aldehydes, ethylmercaptans, ethylene, oils, fats and grease. The contaminants can be in solution or as suspended solids. The present invention is also effective in short time frames not available in other conventional oxidation-based technologies, i.e., complete oxidation of contaminants in minutes, not hours.

The method of the present invention may be carried out within a mass transfer mixing device adapted for enhancing and optimizing the mass transfer of at least one dissolvable gas into a waste fluid. For the purposes of the present invention, “mass transfer” refers to the transfer of a dissolvable gas into a waste fluid and reaction of the dissolvable gas with the waste fluid so that the waste fluid is oxidized as a result.

The dissolvable gas may include an oxidizing agent containing at least one atom selected from the group consisting of oxygen, fluorine, chlorine, bromine, iodine, chromium and manganese. Examples of oxidizing agents include inorganic and organic peroxides, potassium permanganate, and periodic acid. Additional oxidizing agents include ozone, ozone/water reaction decay oxygenation products such as super oxide radical anion, HO₂ (hydroperoxide or hydroxyl radical), ozonide radical ion, hydrogen peroxide, and organic peroxides formed by reaction with contaminants, organic peroxides, UV radiation, or other oxygenation reagents. Still further examples of oxidizing agents include percarbonate, perborate, singlet oxygen, peroxy acids (RCO₃H), hypochlorite, chlorine and chlorine dioxide, metal oxyacids such as all forms of chromium (VI) and permanganate ion, nitric acid, nitrous acid, and sodium peroxide.

One example of a mass transfer mixing device according to the present invention is a high gravity field reactor. High gravity field reactors typically comprise a liquid or gas inlet, a gas or liquid outlet, and an inner chamber. The inner chamber may be packed with media, such as porous fillers, which are known to the skilled persons in the field. The media may be formed of, for example, foam metal or non-metal material, metal or non-metal wire mesh, porous materials such as metal balls, glass balls, ceramic members, metal oxide, or the like.

One particular example of a high gravity field reactor is a Higee reactor. The term “Higee” as used herein refers to a device capable of generating a high gravity field to affect mass transfer between at least two fluids and/or gases. The high gravity field is the result of a centrifugal force field generated by rotation of packed beds in the Higee. The phrase “high gravity field” means that liquid and/or gas reactants are introduced into the high gravity field and react while they are moved centrifugally, or the liquid reactant is moved is moved from the center of the RPB centrifugally and the gas reactant is introduced oppositely with respect to the liquid reactant along the radial direction when the packed bed is rotating. In general, the reaction represented by the phrase “under high gravity” can be carried out in any Higee reactor or any other similar high gravity field reactor.

The centrifugal movement used to obtain the high gravity field according to the present invention can be conducted in a horizontal direction, a vertical direction, or any other arbitrary direction.

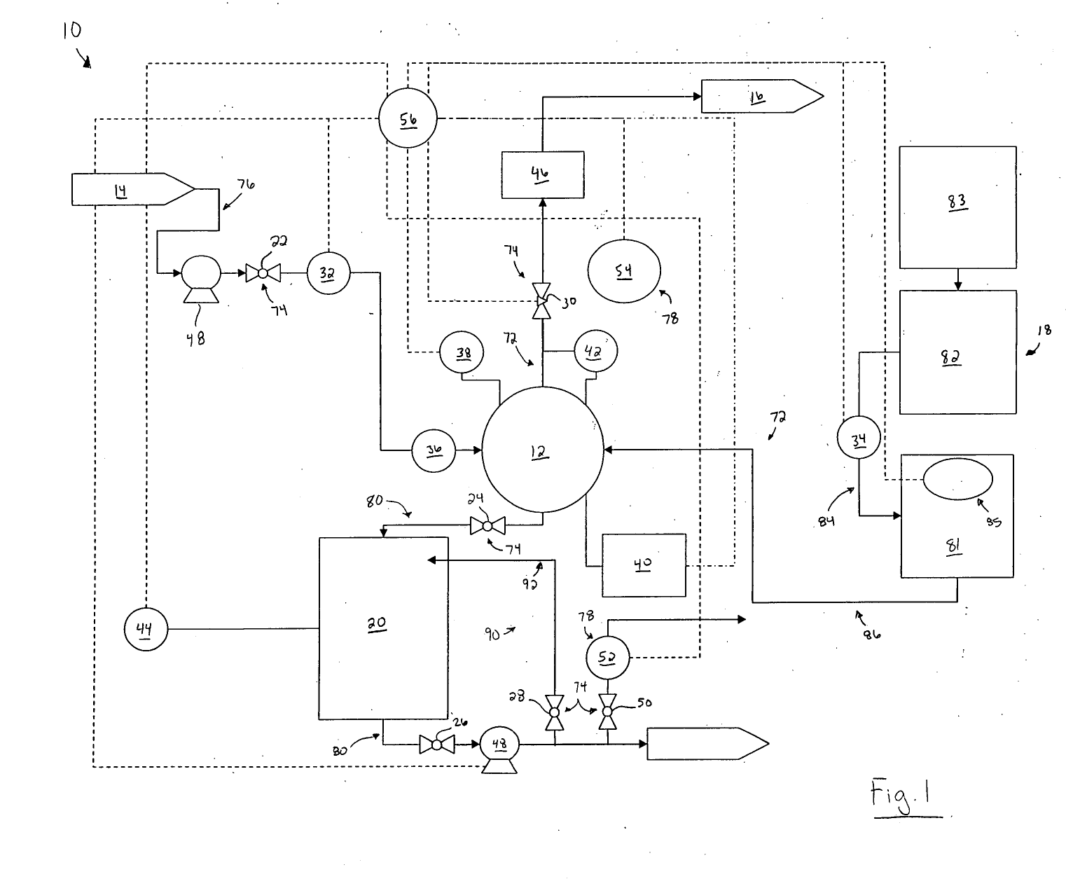

According to one embodiment of the present invention, a method is provided for treating at least one contaminated fluid. The method of the present invention is carried out using a system 10 illustrated in FIG. 1. The system 10 comprises the following components: a RPB reactor 12; a contaminated fluid reservoir 14; a vent 16; a gas generator 18; a treated fluid reservoir 20; a first fluid inlet valve 22; a first fluid outlet valve 24; a second fluid outlet valve 26; a third fluid outlet valve 28; a first gas outlet valve 30; a first flow instrument 32; a first flow control valve 34; a first pressure instrument 36; a second pressure instrument 38; a motor 40; a differential pressure gauge 42; a level control 44; an ozone filter 46; and at least one pump 48. The system 10 may optionally include the additional following components: a fourth fluid outlet valve 50; a first analyzer 52; a second analyzer 54; and a controller 56.

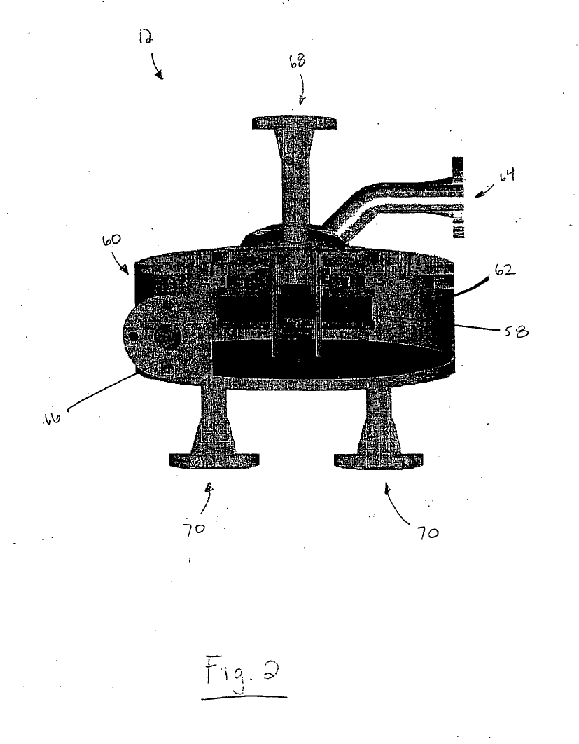

The RPB reactor 12 of the present invention comprises a spinning impingement multiphase contacting device shown in FIG. 2 and disclosed in U.S. patent application Ser. No. 10/971,385 (“the '385 application”), the entirety of which is incorporated herein by reference. The RPB reactor 12 comprises a rotatable permeable element 58 disposed within a chamber 60 defining an interior region 62. The RPB reactor 12 includes at least one liquid inlet 64 for introducing the contaminated fluid into the interior region 62, and at least one gas inlet 66 for introducing a dose of a dissolvable gas into the chamber 60. Additionally, the RPB reactor 12 includes at least one gas outlet 68 for removing the dissolvable gas from the interior region 62, and at least one liquid outlet 70 for removing a fluid from the interior region.

Referring again to FIG. 1, the components of the present invention are assembled using an appropriate number and type of fluid lines 72. All fluid lines 72, fluid connections (not shown), and other hardware may be constructed of non-contaminating materials, such as fluoropolymers, when possible. Additionally or optionally, all fluid lines 72 may comprise corrosion-resistant materials such as hardened plastics and steel alloys (e.g., stainless steel). All fluid lines 72 couple the various components of the present invention together so that both fluids and/or gases can be flowed through the system 10 without appreciable leaking and/or pressure loss.

All the valves 74 of the present invention are operably connected to the fluid line 72 on which they are respectively situated. As a result, each valve 74 can be independently adjusted between an open position and a closed position so that fluid and/or gas flow through a respective fluid line 72 can be allowed or prohibited as desired during operation of the present invention. For example, the first fluid inlet valve 22 is responsible for controlling the flow of contaminated fluid into the liquid inlet 64 of the RPB reactor 12, and the first gas outlet valve 30 is responsible for diverting gas out of the system 10. The use and positioning of valves to control fluid and/or gas flow is common in the art and thus the specifics of operation and positioning will be omitted for purposes of brevity and convenience.

As shown in FIG. 1, at least one pump 48 is coupled to a contaminated fluid flow line 76 to facilitate fluid flow from the contaminated fluid reservoir 14 to the RPB reactor 12. While only a single pump 48 is illustrated for ease of illustration and to avoid clutter of the illustration, those skilled in the art will appreciate that it may be necessary to incorporate additional pumps into other areas of the system 10 at various positions. For example, individual pumps may be supplied to each fluid line 72 that is coupled to the gas generator 18 or the treated fluid reservoir 20. Similarly, mass flow controllers (not shown) can be added as desired to precisely control the mass flow of the gas and/or fluids throughout the system 10. Additional hardware may also include inline heaters (not shown) and/or inline chillers (not shown).

A plurality of analyzers 78, such as concentration and/or temperature sensors, may optionally be included in the system 10. As shown in FIG. 1, for instance, the system 10 may include first and second analyzers 52 and 54. The first analyzer 52 may be operably coupled to a treated fluid outlet line 80, and the second analyzer 54 may be operably coupled to a controller 56 which is also optionally included in the system 10. The first and second analyzers 52 and 54 may be responsible for measuring the concentration of the dissolvable gas. The first analyzer 52 may additionally be responsible for measuring the oxidation reduction potential of the treated fluid. The first and second analyzers 52 and 54 may include conductivity probes (not shown) and/or light-diffraction sensors (not shown). Other types of sensors, however, can be used and are known in the art.

As noted, the system 10 may optionally include a properly programmed controller 56 so that the methods of the present invention can be automated to carry out all functions and processes. Alternatively, the present invention may be carried out by manual control. Where the controller 56 is included in the system 10, all of the hardware and other components of the system, such as valves, pumps, sensors, and/or any mass flow controllers, may be electrically and operably coupled to the controller as indicated by the dashed lines in FIG. 1. For example, the controller 56 may be operatively coupled to a level control 44 that actively measures the level of treated fluid in the treated fluid reservoir 20. Depending upon whether the treated fluid reservoir 20 is filling or draining, the level control 44 and the controller 56 can communicate with one another and modulate the fluid level in the treated fluid reservoir 20 (e.g., by adjusting the activity of the pump 48). The controller 56 can be coupled to additional components of the system 10, such as a motor 40 that provides power to the RPB reactor 12.

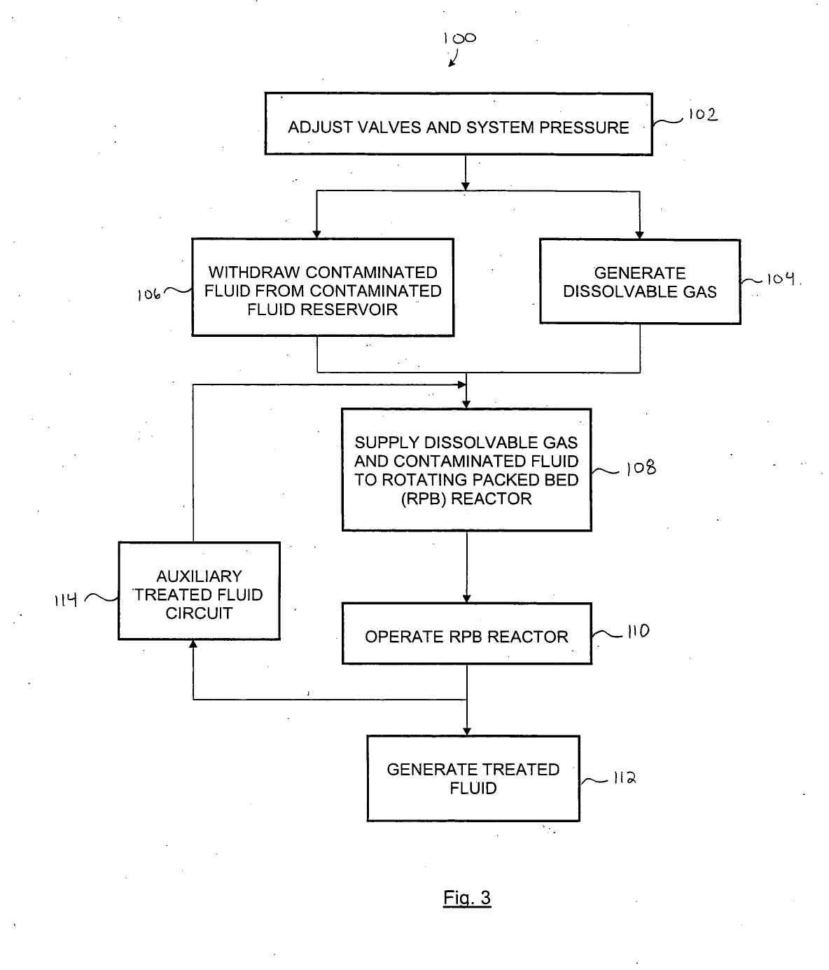

A process 100 for using the system 10 to treat a contaminated fluid in accordance with one embodiment of the present invention is illustrated in FIG. 3. The process 100 of the present invention begins with a step 102. In step 102, all valves 74 are in the closed position and the pumps 48 (or any other pumps) are inactive. It will be appreciated that the system pressure may be uniformly maintained or, alternatively, varied as needed. For example, the system pressure of the present invention may be about 10 psia to about 120 psia. More particularly, the system pressure may be about 14 psia to about 21 psia. The system pressure may be monitored by first and second pressure instruments 36 and 38 which are operably connected to the RPB reactor 12. Additionally, the differential pressure gauge 42, which can indicate the pressure difference between two input connections, may be used to monitor system pressure.

When desired, an activation signal is sent from the controller 56, for example, to the gas generator 18 to produce the dissolvable gas in step 104. To generate ozone gas, for instance, an activation signal is first sent to an ozone generator 81. The ozone gas is created from oxygen that is supplied to the ozone generator 81 from an oxygen reservoir 82 operatively coupled to an air compressor 83. Simultaneously or soon thereafter, the first flow control valve 34 is opened so that a desired flow rate (mass or volumetric) of O₂ gas is provided from the oxygen reservoir 82 to the ozone generator 81. The force needed to flow the O₂ gas can be achieved by pressurizing the oxygen reservoir 82, providing a pump (not shown) on the O₂ gas fluid line 84, providing a pressure differential in the O₂ gas fluid line, or by any other means known in the art. By manipulating the first flow control valve 34 as needed, the flow rate, and thus the dose of ozone gas delivered to the RPB reactor 12 may be appropriately controlled.

As the O₂ gas enters the ozone generator 81, ozone gas is generated and flows through a gas inlet fluid line 86 toward the gas inlet 66 of the RPB reactor 12 at a desired flow rate. The flow rate of the ozone gas may be measured by an ozone sensor 85 that is operably connected to the controller 56. The dose of ozone gas delivered to the RPB reactor 12 may be about 0.5 g O₃/m³ contaminated fluid to about 1000 g O₃/m³ contaminated fluid. More particularly, the dose of ozone gas may be about 0.5 O₃/m³ contaminated fluid to about 130 O₃/m³ contaminated fluid.

Prior to, simultaneous with, or subsequent to the opening of the first flow control valve 34, the first fluid inlet valve 22 is opened in step 106 and the pump 48 activated to withdraw contaminated fluid from the contaminated fluid reservoir 14, into the contaminated fluid flow line 76, and into the RPB reactor 12 at a desired inlet flow rate. For example, an inlet flow rate of about 0.5 gpm to about 2000 gpm may be used. More particularly, an inlet flow rate of about 0.04 gpm to about 2.2 gpm may be used. The inlet flow rate of the contaminated fluid may be monitored by the first flow instrument 32. The temperature of the contaminated fluid can be about 0° C. to about 100° C. More particularly, the temperature of the contaminated fluid can be about 15° C. to about 30° C.

After opening the first flow control valve 34 and the first fluid inlet valve 22, ozone gas and contaminated fluid are respectively supplied to the RPB reactor 12 in step 108. In step 110, the RPB reactor 12 is then operated as described in the '385 application, and under the particular parameters described herein. Significantly, the RPB reactor 12 maximizes the available fluid surface area for mass transfer by continuously shearing and coalescing the incoming fluid. For the purposes of the present invention, the tangential velocity of the rotatable permeable element 58 may be about 4 m/s to about 25 m/s. More particularly, the tangential velocity of the rotatable permeable element 58 may be about 5.3 m/s to about 18.4 m/s.

As the combined stream of contaminated fluid and ozone gas is flowed through the RPB reactor 12, the ozone gas becomes dissolved in the contaminated fluid, the contaminants in the contaminated fluid are oxidized, and a treated fluid having a reduced number of contaminants is generated. After being subject to the shearing action of the RPB reactor 12, the treated fluid flows out of the liquid outlet 70, through the treated fluid outlet line 80, and into the treated fluid reservoir 20. A pump 48 operably connected to the treated fluid outlet line 80 may then be used to flow the treated fluid through the second fluid outlet valve 26 so that the fluid may be collected as needed.

In step 112, the contaminated fluid and the ozone gas are continually supplied to the RPB reactor 12 until a desired amount of treated fluid is produced. As discussed above, the amount of treated fluid in the treated fluid reservoir 20 can be monitored by the level control 44. Alternatively, mass flow controllers, load cells (not shown), or the like can be used to determine how much treated fluid is in the treated fluid reservoir 20.

Once the desired amount of treated fluid is produced, the second fluid outlet valve 24 is closed to terminate the flow of contaminated fluid into the RPB reactor 12. The ozone gas flow may be allowed to continue or may be terminated, depending upon the concentration of ozone desired in the treated fluid. For example, where the concentration of dissolved ozone is at a desired level, the first flow control valve 34 may be turned to the closed position to stop the flow of ozone gas into the RPB reactor 12.

Alternatively, where the concentration of dissolved ozone in the treated fluid is not desirable, an auxiliary treated fluid circuit 90 may be employed in step 114. The auxiliary treated fluid circuit 90 may comprise a treated fluid recirculation line 92 operably connected between the treated fluid reservoir 20 and the treated fluid outlet line 80. A third fluid outlet valve 28 for modulating fluid flow through the treated fluid recirculation line 92 may also be included in the circuit 90. As the treated fluid is re-circulated through the circuit 90, the ozone concentration may increase to a desired level. When the concentration of ozone in the treated fluid reaches a desired level, use of the auxiliary treated fluid circuit 90 may then be discontinued.

During operation of the system 10, non-dissolved ozone gas is removed from the system by the vent 16. Prior to exiting the vent 16, non-dissolved ozone gas may flow through the first gas outlet valve 30 and into the ozone filter 46. The ozone filter 46 neutralizes or destroys non-dissolved ozone so that the ozone is not released into the atmosphere. The ozone filter 46 may include, for example, a UV chamber or an activated charcoal filter. The filtered gas may then flow out of the system 10 through the vent 16.

Where the controller 56 is included in the present invention, the controller may receive a signal from the first analyzer 52 indicating that the measured ozone concentration of the treated fluid is substantially equal to or greater than the desired ozone concentration. In such a case, the system controller 56 may automatically close the first flow control valve 34 to discontinue the flow of ozone into the RPB reactor 12.

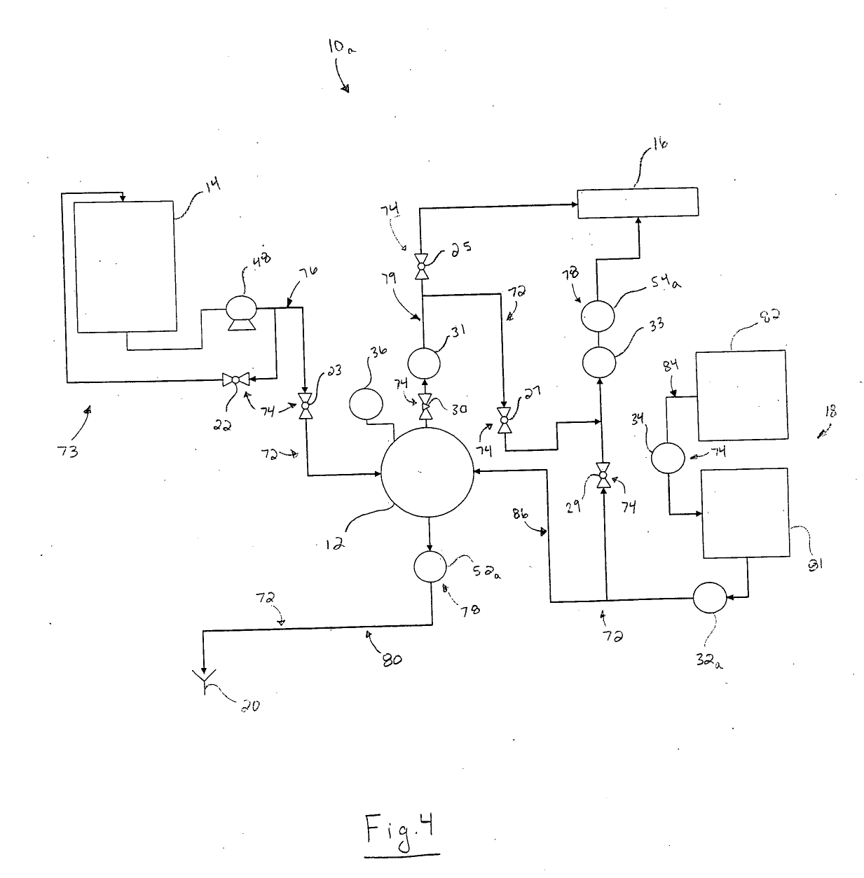

Illustrated in FIG. 4 is another embodiment of the present invention comprising a system 10ₐ for treating at least one contaminated fluid. The system 10ₐ is identically constructed as the system 10 illustrated in FIG. 1, except where as described below. In FIG. 4, components of the system 10ₐ that are identical as components of FIG. 1 use the same reference numbers, whereas components that are similar but not identical carry the suffix “a”.

The system 10ₐ comprises the following components: a RPB reactor 12; a contaminated fluid reservoir 14; a vent 16; a gas generator 18; a treated fluid reservoir 20; a first fluid inlet valve 22; a second fluid inlet valve 23; a first gas outlet valve 30; a second gas outlet valve 25; a third gas outlet valve 27; a first gas inlet valve 29; a first flow instrument 32ₐ; a third flow instrument 31; a first flow control valve 34; a second flow control instrument 33; a first analyzer 52ₐ; a second analyzer 54ₐ; a first pressure instrument 36; and at least one pump 48. Other components of the system 10ₐ which are optional, or are not illustrated in FIG. 4, are discussed below.

Referring to FIG. 4, the components of the present invention are assembled using an appropriate number and type of fluid lines 72. All fluid lines 72 couple the various components of the present invention together so that both fluids and/or gases can be flowed through the system 10ₐ without appreciable leaking and/or pressure loss.

All the valves 74 of the system 10ₐ are operably connected to the fluid line 72 on which they are respectively situated. As a result, each valve 74 can be independently adjusted between an open position and a closed position so that fluid and/or gas flow through a respective fluid line 72 can be allowed or prohibited as desired during operation of the present invention. For example, the first and second fluid inlet valves 22 and 23 are responsible for controlling the flow of contaminated fluid into the liquid inlet 64 of the RPB reactor 12. Additionally, the first, second, and third gas outlet valves 30, 25, and 27 are responsible for diverting gas through the second analyzer 54ₐ. The use and positioning of valves to control fluid and/or gas flow is common in the art and thus the specifics of operation and positioning will be omitted for purposes of brevity and convenience.

As shown in FIG. 4, at least one pump 48 is coupled to a contaminated fluid flow line 76 to facilitate fluid flow from the contaminated fluid reservoir 14 to the RPB reactor 12. The contaminated fluid flow line 76 further comprises a recirculation circuit 73 so that contaminated fluid may be re-circulated as needed. While only a single pump 48 is illustrated for ease of illustration and to avoid clutter of the illustration, those skilled in the art will appreciate that it may be necessary to incorporate additional pumps not only into the recirculation circuit 73, but also into other areas of the system 10ₐ at various positions. For example, individual pumps may be supplied to each fluid line 72 that is coupled to the gas generator 18 or the treated fluid reservoir 20. Similarly, mass flow controllers (not shown) can be added as desired to precisely control the mass flow of the gas and/or fluids throughout the system 10ₐ. Additional hardware may also include inline heaters (not shown) and/or inline chillers (not shown).

A plurality of analyzers 78, such as concentration and/or temperature sensors are also be included in the system 10ₐ. For instance, the system 10ₐ includes first and second analyzers 52ₐ and 54ₐ. The first analyzer 52ₐ is operably coupled to a treated fluid outlet line 80, and the second analyzer 54ₐ is operably coupled to a gas outlet line 79. The first and second analyzers 52ₐ and 54ₐ are responsible for measuring the concentration of the dissolvable gas. The first analyzer 52ₐ is additionally responsible for measuring the temperature of the treated fluid. The first and second analyzers 52ₐ and 54ₐ may include conductivity probes (not shown) and/or light-diffraction sensors (not shown). Other types of sensors, however, can be used and are known in the art.

The system 10ₐ may additionally comprise a properly programmed controller (not shown) so that the methods of the present invention can be automated to carry out all functions and processes. Alternatively, the present invention may be carried out by manual control. Where a controller is included in the system 10ₐ, all of the hardware and other components of the system, such as valves, pumps, sensors, and/or any mass flow controllers, may be electrically and operably coupled to the controller. The controller may also be coupled to the hardware incorporated into the contaminated fluid and treated fluid reservoirs 14 and 20.

A process 100 for using the system 10ₐ to treat a contaminated fluid is illustrated in FIG. 3. The process 100 begins with a step 102. In step 102, all valves 74 are in the closed position and the pump 48 (or any other pumps) is inactive. The skilled artisan will appreciate that the system pressure may be uniformly maintained or, alternatively, varied as needed. For example, the system pressure of the present invention may be about 10 psia to about 120 psia. More particularly, the system pressure may be about 14 psia to about 21 psia. The system pressure may be monitored by the first pressure instrument 36, which is operably connected to the RPB reactor 12.

When desired, an activation signal is sent to the gas generator 18 to produce the dissolvable gas in step 104. To generate ozone gas, for instance, an activation signal is first sent to an ozone generator 81. The ozone gas is created from oxygen that is supplied to the ozone generator 81 from an oxygen reservoir 82. The gas generator 18 may additionally comprise an air compressor (not shown) operatively coupled to the oxygen reservoir 82. Simultaneously or soon thereafter, the first flow control valve 34 is opened so that a desired flow rate (mass or volumetric) of O₂ gas is provided from the oxygen reservoir 82 to the ozone generator 81. The force needed to flow the O₂ gas can be achieved by pressurizing the oxygen reservoir 82, providing a pump (not shown) on the O₂ gas fluid line 84, providing a pressure differential in the O₂ gas fluid line, or by any other means known in the art. By manipulating the first flow control valve 34 as needed, the flow rate, and thus the dose of ozone gas delivered to the RPB reactor 12 may be appropriately controlled.

As the O₂ gas enters the ozone generator 81, ozone gas is generated and flows through a gas inlet fluid line 86 toward the gas inlet 66 of the RPB reactor 12 at a desired flow rate. The flow rate of the ozone gas is measured by the first flow instrument 32ₐ, which is operably connected to the gas inlet fluid line 86. The dose of ozone gas delivered to the RPB reactor 12 may be about 0.5 g O₃/m³ contaminated fluid to about 1000 g O₃/m³ contaminated fluid. More particularly, the dose of ozone gas may be about 0.5 O₃/m³ contaminated fluid to about 130 O₃/m³ contaminated fluid.

Prior to, simultaneous with, or subsequent to the opening of the first flow control valve 34, the second fluid inlet valve 23 is opened in step 106 and the pump 48 activated to withdraw contaminated fluid from the contaminated fluid reservoir 14, into the contaminated fluid flow line 76, and into the RPB reactor 12 at a desired inlet flow rate. For example, an inlet flow rate of about 0.5 gpm to about 2000 gpm may be used. More particularly, an inlet flow rate of about 0.04 gpm to about 2.2 gpm may be used. The inlet flow rate of the contaminated fluid may be modulated by opening the first fluid inlet valve 22 and permitting contaminated fluid to re-circulate via the recirculation circuit 73 into the contaminated fluid reservoir 14. The temperature of the contaminated fluid can be about 0° C. to about 1000° C. More particularly, the temperature of the contaminated fluid can be about 15° C. to about 30° C.

After opening the first flow control valve 34 and the second fluid inlet valve 23, ozone gas and contaminated fluid are respectively supplied to the RPB reactor 12 in step 108. In step 110, the RPB reactor 12 is then operated as described in the '385 application, and under the particular parameters described herein. For the purposes of the present invention, the tangential velocity of the rotatable permeable element 58 may be about 4 m/s to about 25 m/s. More particularly, the tangential velocity of the rotatable permeable element 58 may be about 5.3 m/s to about 18.4 m/s.

As the combined stream of contaminated fluid and ozone gas is flowed through the RPB reactor 12, the ozone gas becomes dissolved in the contaminated fluid, the contaminants in the contaminated fluid are oxidized, and a treated fluid having a reduced number of contaminants is generated. After being subject to the shearing action of the RPB reactor 12, the treated fluid flows out of the liquid outlet 70, through the treated fluid outlet line 80, and into the treated fluid reservoir 20.

In step 112, the contaminated fluid and the ozone gas are continually supplied to the RPB reactor 12 until a desired amount of treated fluid is produced. The amount of treated fluid in the treated fluid reservoir 20 can be monitored by a liquid control (not shown). Alternatively, mass flow controllers, load cells (not shown), or the like can be used to determine how much treated fluid is in the treated fluid reservoir 20.

Once the desired amount of treated fluid is produced, the second fluid inlet valve 23 is closed to terminate the flow of contaminated fluid into the RPB reactor 12. The ozone gas flow may be allowed to continue or may be terminated, depending upon the concentration of ozone desired in the treated fluid. For example, where the concentration of dissolved ozone is at a desired level, the first flow control valve 34 may be turned to the closed position to stop the flow of ozone gas to the RPB reactor 12. Alternatively, where the concentration of dissolved ozone in the treated fluid is not desirable, an auxiliary treated fluid circuit (not shown) that is similar to or identical with the auxiliary treated fluid circuit 90 illustrated in FIG. 1 may be included in the system 10ₐ.

During operation of the system 10ₐ, non-dissolved ozone gas is removed from the system by the vent 16. Non-dissolved ozone gas may flow through the first gas outlet valve 30, through the third flow instrument 31, through the second gas outlet valve 25, and then out the vent 16. An ozone filter (not shown) may be operatively coupled to the gas outlet line 79 to destroy or neutralize non-dissolved ozone. The third flow instrument 31 is responsible for measuring the gas flow rate out of the gas outlet 68. Alternatively, the second gas outlet valve 25 can be partially or completely closed to permit non-dissolved gas to flow through the third gas outlet valve 27, through the second flow control instrument 33, into the second analyzer 54ₐ, and then out of the vent 16. The second flow control instrument 33 is responsible for both measuring the gas flow rate to the second analyzer 54ₐ, and for controlling the gas flow rate.

Where a system controller is included in the present invention, the system controller may receive a signal from the first analyzer 52ₐ indicating that the measured ozone concentration of the treated fluid is substantially equal to or greater than the desired ozone concentration. In such a case, the system controller may automatically close the first flow control valve 34 to discontinue the flow of ozone into the RPB reactor 12.

The present invention permits high mass transfer efficiency at low pressure and at low ozone gas concentration. A mass transfer efficiency of at least 80%, for example, can be achieved under the following parameters: using the RPB reactor 12 having a rotor packing material of solid nickel-plated aluminum foam metal (about 200 pores/m, about 0.23 m O.D., about 0.1 m I.D., and about 0.038 m axial thickness), wherein the rotatable permeable element 58 has a tangential velocity of about 18.4 m/s; providing a liquid inlet flow rate of about 0.32 m³/h; providing an ozone dose of about 22.6 g O₃/N m³ contaminated fluid; providing a system pressure of about 17 psia; and maintaining the liquid inlet temperature at about 23.9° C. Additional examples illustrating the high mass transfer efficiency of the present invention are provided below.

In another embodiment of the present invention, the contaminated fluid may comprise water, such as tap water, filtered water, or pure water. Employing the methods of the present invention as described above, the water may be treated with ozone to produce a desired volume of ozonated water. The ozonated water may be used for a variety of domestic and/or commercial processes. For example, ozonated water generated by the present invention may be sprayed onto livestock to eliminate microorganisms and thus reduce or prevent disease. Additionally, ozonated water generated by the present invention may be used in aquaculture (e.g., disinfecting aquariums, pools, spas, and aquatic gardens), bottling operations, with cooling towers (e.g., to reduce microbial growth and prevent corrosion), to whiten pulp and/or paper products, and to improve the efficiency of commercial laundry processes.

It should be appreciated that the present invention may also include a plurality of RPB reactors particularly arranged to achieve, for example, greater flow rates and ozone dosages. For instance, the present invention can include a plurality of RPB reactors arranged in parallel (not shown) to handle higher fluid flow rates. Alternatively, the present invention can include a plurality of RPB reactors arranged in series (not shown) to increase ozone dosage and treat contaminated fluid(s) using multiple passes.

The present invention is further illustrated by the following examples, which are not intended to limit the scope of potential applications of the invention.

### EXAMPLES Examples 1-16

Each of examples 1 through 16 illustrated in Table 1 was conducted with a rotor packing material of solid nickel-plated aluminum foam metal, about 200 pores/m, about 0.23 m O.D, about 0.1 m I.D, and about 0.025 m axial thickness. The tangential velocity at the inner diameter of the rotatable permeable element 58 was varied from 5.3 m/sec to 18.4 m/sec. The ozone was contacted with city water. The inlet and outlet gas was measured for ozone concentration using a BMT high concentration ozone analyzer. The ozone content of the product flow was measured by an ATI Q45H dissolved ozone analyzer.

In Table 1, the tangential-velocity is given in column V_{T} in m/s. The liquid inlet flow rate is given in column Fᵢ in m³/h. The ozone applied dose is given in column O₃ dose in g O₃/m³ water. The inlet ozone gas concentration is given in column O₃ inlet in g/N m³. The system pressure is given in column P_{system} in torr. The liquid temperature is given in column Tᵢₙₗₑₜ in °C. The ozone dissolved is given in column O_{3 dissolved} in g/m³.

TABLE 1
Ozone Absorption in City Water

| | | | O_{3 dose} | | | | |
|---|---|---|---|---|---|---|---|
| | | | (g O₃/m³ | O_{3 inlet} | P_{system} | Tᵢₙₗₑₜ | O_{3 dissolved} |
| Example | V_{T} (m/s) | Fᵢ (m³/h) | water) | (g/N m³) | (torr) | (° C.) | (g/m³) |
| 1 | 5.3 | 0.045 | 18.2 | 63.5 | 760 | 23.6 | 9.53 |
| 2 | 18.4 | 0.182 | 26.5 | 64.9 | 760 | 22.8 | 11.30 |
| 3 | 5.3 | 0.177 | 27.4 | 56.9 | 1044 | 21.5 | 13.74 |
| 4 | 18.4 | 0.045 | 22.5 | 68.0 | 1019 | 23.7 | 12.12 |
| 5 | 5.3 | 0.182 | 2.0 | 24.5 | 1024 | 22.4 | 1.87 |
| 6 | 18.4 | 0.182 | 1.6 | 22.5 | 760 | 23.3 | 1.38 |
| 7 | 18.4 | 0.045 | 44.0 | 23.3 | 1024 | 25.9 | 7.84 |
| 8 | 5.3 | 0.045 | 34.1 | 21.5 | 760 | 24.5 | 6.64 |
| 9 | 18.4 | 0.045 | 6.3 | 22.2 | 760 | 25.5 | 3.64 |
| 10 | 5.3 | 0.182 | 8.8 | 21.9 | 760 | 23.5 | 4.12 |
| 11 | 5.3 | 0.045 | 8.6 | 23.3 | 1044 | 24.5 | 5.08 |
| 12 | 18.4 | 0.182 | 11.8 | 25.3 | 1039 | 23.2 | 5.79 |
| 13 | 5.3 | 0.045 | 121.5 | 65.4 | 1039 | 24.6 | 22.31 |
| 14 | 5.3 | 0.182 | 4.6 | 64.7 | 760 | 22.5 | 4.14 |
| 15 | 18.4 | 0.045 | 105.2 | 65.5 | 770 | 26.6 | 16.85 |
| 16 | 18.4 | 0.182 | 5.7 | 68.2 | 1029 | 22.9 | 5.34 |

In Examples 5 and 16, the mass transfer efficiency was above 90%. This is exceptional performance at low pressure and low ozone gas concentration. In Examples 7, 8, 13 and 15, the water was supersaturated with ozone. In all Examples ozone was efficiently dissolved into the water.

### Examples 17 and 18

Table 2 illustrates examples 17 and 18 in which COD (chemical oxygen demand) was reduced in an industrial wastewater stream using ozone oxidation with the RPB reactor 12 of the present invention as the contator. A rotor packing material of solid nickel-plated aluminum foam metal, about 200 pores/m, about 0.23 m O.D, about 0.1 m I.D, and about 0.038 m axial thickness was used. The tangential velocity at the inner diameter of the rotatable permeable element 58 was kept constant at about 18.4 m/sec. The inlet and outlet gas was measured for ozone concentration using an IN-USA H1-X high concentration ozone analyzer. COD was measured on the inlet and outlet streams using the reactor digestion method. The COD of the inlet wastewater was 8280 mg/L.

In Table 2, the liquid inlet flow rate is given in column Fᵢ in m³/h. The ozone applied dose is given in column O₃ dose in g O₃/m³ water. The inlet ozone gas concentration is given in column O_{3 inlet} in g/N m³. The system pressure is given in column P_{system} in torr. The liquid temperature is given in column Tᵢₙₗₑₜ in °C. The ozone dissolved is given in column O₃ dissolved in g/m³. The COD outlet stream is given in column CODₒ in mg/L.

TABLE 2
COD Destruction in an Industrial Wastewater Stream Using Ozone

| | | O_{3 dose} | | | | | |
|---|---|---|---|---|---|---|---|
| | Fᵢ | (g O₃/m³ | O_{3 inlet} | P_{system} | Tᵢₙₗₑₜ | O_{3 dissolved} | CODₒ |
| Example | (m³/h) | water) | (g/N m³) | (torr) | (° C.) | (g/m³) | (mg/L) |
| 17 | 0.32 | 22.6 | 80.8 | 879 | 23.9 | 22.6 | 5690 |
| 18 | 0.068 | 122.6 | 20.7 | 850 | 23.9 | 105 | 5320 |

As can be seen from Table 2, the COD concentration was reduced significantly at both dose levels. Also, 100% transfer efficiency was achieved in Example 17 at a 22.6 g/m³ ozone dose, and an 86% mass transfer efficiency was achieved at the 122.6 mg/L ozone dose.

From the above description of the invention, those skilled in the art will perceive improvements, changes and modifications. For example, the treated fluid of the present invention may be subject to various post-treatment processes and devices, such as adsorbers (not shown), biofilters (not shown), or other additional contaminant-capturing devices. Additionally, the treated fluid may be subjected to electron beam, ultrasonics, UV radiation, magnetic field or electromagnetic radiations. Such improvements, changes and modifications within the skill of the art are intended to be covered by the appended claims.

1. A method for treating a contaminated fluid, said method comprising the steps of:
providing a rotating packed bed (RPB) reactor, the RPB reactor comprising a rotatable permeable element disposed within a chamber and defining an interior region, at least one liquid inlet for infusing the contaminated fluid into the interior region, at least one gas inlet for introducing a dose of at least one dissolvable gas into the chamber, at least one gas outlet for removing the at least one dissolvable gas from the interior region, and at least one liquid outlet for removing a fluid from the interior region;
causing the rotatable permeable element within the RPB reactor to spin at a tangential velocity;
infusing the contaminated fluid into the at least one liquid inlet at an inlet flow rate; infusing the dose of the at least one dissolvable gas into the at least one gas inlet; and
generating a treated fluid having a reduced number of contaminants.

2. The method of claim 1 wherein said step of infusing the contaminated fluid into the at least one liquid inlet further comprises the steps of:
dispersing the contaminated fluid into a highly dispersed phase; and
continuously renewing the highly dispersed phase within the rotatable permeable element.

3. The method of claim 2 wherein the tangential velocity of the rotatable permeable element is about 4 m/s to about 25 m/s.

4. The method of claim 2 wherein said step of causing the rotatable permeable element within the RPB reactor to spin at a tangential velocity enhances dispersion of the contaminated fluid, wherein contact between the dispersed contaminated fluid and the at least one dissolvable gas causes dissolution of the at least one dissolvable gas into the dispersed contaminated fluid.

5. The method of claim 1 wherein said step of infusing the dose of the at least one dissolvable gas into the at least one gas inlet causes the at least one dissolvable gas to travel through the rotatable permeable element, contact the dispersed contaminated fluid, and exit the RPB reactor through the at least one liquid outlet.

6. The method of claim 1 wherein the inlet flow rate of the contaminated fluid is about 0.5 gpm to about 2000 gpm.

7. The method of claim 1 wherein the temperature of the contaminated fluid is about 0° C. to about 100° C.

8. The method of claim 1 wherein the RPB reactor has a system pressure of about 10 psia to about 120 psia.

9. The method of claim 1 wherein the dose of the at least one dissolvable gas includes at least one atom selected from the group consisting of oxygen, fluorine, chlorine, bromine, iodine, chromium and manganese.

10. The method of claim 1 wherein the dose of the at least one dissolvable gas includes ozone.

11. The method of claim 10 wherein the dose of ozone is about 0.5 g O₃/m³ contaminated fluid to about 1000 g O₃/m³ contaminated fluid.

12. The method of claim 10 wherein the amount of ozone dissolved in the treated fluid is about 0.2 g/m³ to about 50 g/m³.

13. The method of claim 10 wherein the flow of ozone is about 0.5 cfh to about 16,000 cfh.

14. The method of claim 1 wherein the contaminated fluid is waste water.

15. A method for treating a contaminated fluid, said method comprising the steps of:
providing a rotating packed bed (RPB) reactor, the RPB reactor comprising a rotatable permeable element disposed within a chamber and defining an interior region, at least one liquid inlet for infusing the contaminated fluid into the interior region, at least one gas inlet for introducing a dose of ozone into the chamber, at least one gas outlet for removing the ozone from the interior region, and at least one liquid outlet for removing a fluid from the interior region;
causing the rotatable permeable element within the RPB reactor to spin at a tangential velocity;
infusing the contaminated fluid into the at least one liquid inlet at an inlet flow rate;
infusing the dose of ozone into the at least one gas inlet; and generating a treated fluid having a reduced number of contaminants.

16. The method of claim 15 wherein said step of infusing the contaminated fluid into the at least one liquid inlet further comprises the steps of:
dispersing the contaminated fluid into a highly dispersed phase; and
continuously renewing the highly dispersed phase within the rotatable permeable element.

17. The method of claim 16 wherein said step of causing the rotatable permeable element within the RPB reactor to spin at a tangential velocity enhances dispersion of the contaminated fluid, wherein contact between the dispersed contaminated fluid and the ozone causes dissolution of the ozone into the dispersed contaminated fluid.

18. The method of claim 15 wherein said step of infusing the dose of ozone into the at least one gas inlet causes the ozone to travel through the rotatable permeable element, contact the dispersed contaminated fluid, and exit the RPB reactor through the at least one liquid outlet.

19. The method of claim 16 wherein the tangential velocity of the rotatable permeable element is about 4 m/s to about 25 m/s.

20. The method of claim 15 wherein the inlet flow rate of the contaminated fluid is about 0.5 gpm to about 2000 gpm.

21. The method of claim 15 wherein the temperature of the contaminated fluid is about 0° C. to about 100° C.

22. The method of claim 15 wherein the dose of ozone is about 0.5 g O₃/m³ contaminated fluid to about 1000 g O₃/m³ contaminated fluid.

23. The method of claim 15 wherein the RPB reactor has a system pressure of about 10 psia to about 120 psia.

24. The method of claim 15 wherein the amount of ozone dissolved in the treated fluid is about 0.2 g/m³ to about 50 g/m³.

25. The method of claim 15 wherein the flow of ozone is about 0.5 cfh to about 16,000 cfh.

26. The method of claim 1 wherein the contaminated fluid is waste water.
